(19) United States
(12) Patent Application Publication
(10) Pub. No.: US 2025/0183318 A1
(43) Pub. Date: Jun. 5, 2025

(54) CATHODE COMPOSITION FOR LITHIUM-ION BATTERIES

(71) Applicant: APB Corporation, Echizen-shi, Fukui (JP)

(72) Inventors: Hideaki HORIE, Echizen-shi, Fukui (JP); Tatsuro SASAKI, Echizen-shi, Fukui (JP); Takuya MIYAMURA, Kyoto-shi, Kyoto (JP); Hideki ISHITANI, Kyoto-shi, Kyoto (JP)

(21) Appl. No.: 18/836,754

(22) PCT Filed: Feb. 16, 2023
(86) PCT No.: PCT/JP2023/005500

§ 371 Date: Aug. 8, 2024

(30) Foreign Application Priority Data
Feb. 17, 2022 (JP) 2022-022780

(51) Int. Cl. H01M 4/66; H01M 4/02; H01M 4/62; H01M 10/0525

(52) U.S. Cl. CPC H01M 4/66; H01M 4/622; H01M 10/0525; H01M 2004/021; H01M 2004/028

(57) ABSTRACT

A cathode composition for lithium-ion batteries comprises: a coated cathode active material particle, wherein at least a part of a cathode active material particle surface is coated by a coating layer that contains a polymer compound; and a conductive filler, wherein the ratio of an aerated bulk density to a packed bulk density (aerated bulk density/packed bulk density) is 0.47 to 0.65.

### FIELD OF THE INVENTION

This invention relates to a cathode composition for lithium-ion batteries.

### BACKGROUND ART

Lithium-ion batteries have come to be widely used in a variety of usages as secondary batteries that can achieve high energy density and high-power density. As a method of producing a lithium-ion battery, a method of compression molding an electrode active material using a roll press has been studied (for example, Patent References 1 and 2). By compression molding the electrode active material using a roll press, the time and energy required for electrode production can be reduced.

In Patent Reference 1, an electrode material powder containing an electrode active material and a binder is supplied to a region surrounded by a pair of rolls and an end flow straightening member. A method for producing an electrode layer by pressure-molding the electrode material powder is disclosed.

In Patent Reference 2, granules containing an electrode active material, a binder, and water are supplied between a pair of rolls, and the granules are compression molded by the pair of rolls. Thus, a method for manufacturing an electrode is disclosed, wherein the method includes the step of forming an electrode mixture layer and the step of disposing the electrode mixture layer on an electrode current collector.

### CITATION LIST

### Patent Literature

[Patent Reference 1] Publication of Japanese Patent No. 5772429

[Patent Reference 2] Japanese Unexamined Patent Application Publication No. 2018-85182

### BRIEF SUMMARY OF THE INVENTION

### Problems that Invention is to Solve

However, when an electrode active material is compression molded using a roll press as described in Patent References 1 or 2, cracks often occur in the electrode. The present invention has been made in view of the above-mentioned problems and has an objective to provide a cathode composition for lithium-ion batteries that can reduce cracks that occur in an electrode wherein the electrode is compression molded by a roll press.

### Means to Solve the Problems

The present inventors have reached the present invention as a result of intensive studies to solve the above problems. This invention is a cathode composition for lithium-ion batteries, which comprises: a coated cathode active material particle, wherein at least a part of a cathode active material particle surface is coated by a coating layer that contains a polymer compound; and a conductive filler, wherein the ratio of an aerated bulk density to a packed bulk density (aerated bulk density/packed bulk density) is 0.47 to 0.65.

### Effects of the Invention

According to this invention, a cathode composition for lithium-ion batteries that can reduce cracks that occur in an electrode can be provided, wherein the electrode is compression molded by a roll press.

### DESCRIPTION OF EMBODIMENTS

Hereinafter, this invention will be described in detail.

This invention related to a cathode composition for lithium-ion batteries.

In the present specification, the lithium-ion battery in a case of being described shall include a concept of a lithium-ion secondary battery as well.

The cathode composition for lithium-ion batteries according to this invention comprises: a coated cathode active material particle, wherein at least a part of a cathode active material particle surface is coated by a coating layer that contains a polymer compound; and a conductive filler, wherein the ratio of an aerated bulk density to a packed bulk density (aerated bulk density/packed bulk density) is 0.47 to 0.65. As long as the ratio of the aerated bulk density to the packed bulk density is within the above range, cracks are unlikely to occur in electrodes, which are obtained by compression molding using the cathode composition for lithium-ion batteries. As a result, the electrodes have high strength and can be made thinner. Further, the ratio of an aerated bulk density to a packed bulk density (aerated bulk density/packed bulk density) may be 0.55 to 0.65.

In this specification, the aerated bulk density is a bulk density measured in accordance with JIS K 6219-2 (2005) using a cylindrical container having a capacity of 100 cm³ and a diameter of 30 mm. The packed bulk density (also called tapped density) is the bulk density measured in accordance with JIS K 5101-12-2 (2004) using a drop height of 5 mm and 2000 tamping (also called tapping or up-and-down vibration) cycles. The aerated bulk density and the packed bulk density are each calculated based on the average of the five measurements.

Examples of the cathode active material particle constituting a coated cathode active material particles include a composite oxide of lithium and a transition metal {a composite oxido having one kind of transition metal (LiCoO₂, LiNiO₂, LiAlMnO₄, LiMnO₂, LiMn₂C₄, or the like), a composite oxide having two kinds of transition metal elements (for example, LiFeMnO4, LiNi₁₋ₓCoₓO₂, LiMn_{1-y}CO_{y}O₂, LiNi_{1/3}CO_{1/3}Al_{1/3}O₂, and LiNi_{0.8}Co_{0.15}Al_{0.05}O₂), a composite oxide having three or more kinds of metal elements [for example, LiMₐM′_{b}M″_{c}O₂ (where M, M′, and M″ are transition metal elements different each other and satisfy a+b+c=1, and one example is LiNi_{1/3}Mn_{1/3}CO_{1/3}O₂)], or the like}, a lithium-containing transition metal phosphate (for example, LiFePO₄, LiCoPO₄, LiMnPO₄, or LiNiPO₄), a transition metal oxide (for example, MnO₂ and V₂O₅), a transition metal sulfide (for example, MoS₂ or TiS₂), and a conductive macromolecule (for example, polyaniline, polypyrrole, polythiophene, polyacetylene, poly-p-phenylene, or polyvinyl carbazole). Two or more thereof may be used in combination. Here, the lithium-containing transition metal phosphate may be one in which a part of transition metal sites is substituted with another transition metal.

The volume average particle size of the cathode active material particles is preferably 0.01 to 100 μm, more preferably 0.1 to 35 μm, and still more preferably 2 to 30 μm, from the viewpoint of the electrical characteristics of the battery. In this specification, the volume average particle size means the particle size (Dv50) at an integrated value of 50% in the particle size distribution obtained by the microtrack method (the laser diffraction/scattering method). The microtrack method is a method of determining a particle size distribution by using scattered light obtained by irradiating particles with laser light. A MICROTRAC manufactured by Nikkiso Co, Ltd. can be used for measuring the volume average particle size.

The coating layer that coats at least a portion of the surface of the cathode active material particles contains a polymer compound. The polymer compound is preferably a resin containing a polymer having the acrylic monomer (a) as an essential constituent monomer and the like. Specifically, the polymer compound constituting the coating layer of the coated cathode active material particles is preferably a polymer of a monomer composition containing acrylic acid (a0) as the acrylic monomer (a). In terms of the above monomer composition, the content of acrylic acid (a0) is preferably 90 wt % or more and 98 wt % or less based on the weight of the entire monomer. The content of acrylic acid (a0) is preferably 93.0˜97.5 wt % and more preferably 95.0˜97.0 wt % based on the weight of the entire monomer from the point of flexibility of the coating layer

As the acrylic monomer (a), the polymer compound constituting the coating layer may contain a monomer (a1) having a carboxyl group or an acid anhydride group other than acrylic acid (a0).

Examples of the monomer (a1) having a carboxyl group or an acid anhydride group other than acrylic acid (a0) are monocarboxylic acids with 3 to 15 carbon atoms such as methacrylic acid, crotonic acid, and cinnamic acid; dicarboxylic acids with 4 to 24 carbon atoms such as (anhydrous) maleic acid, fumaric acid, itaconic acid, citraconic acid, and mesaconic acid (anhydrous); Trivalent to tetravalent or higher valence polycarboxylic acids having 6 to 24 carbon atoms such as aconitic acid, etc.

The polymer compound constituting the coating layer may contain a monomer (a2) represented by the following formula (1) as the acrylic monomer (a).

CH₂═C(R¹)COOR² (1)

[In formula (1), R¹ is a hydrogen atom or a methyl group, and R² is a straight chain having 4 to 12 carbon atoms or a branched alkyl group having 3 to 36 carbon atoms.]

In terms of the monomer (a2) shown in formula (1), R¹ represents a hydrogen atom or a methyl group. Preferably, R¹ is a methyl group. R² is preferably a straight chain or branched alkyl group having 4 to 12 carbon atoms, or a branched alkyl group having 13 to 36 carbon atoms.

The monomer (a2) is classified into (a21) and (a22) depending on the group R².
(a21) Ester compound in which R² is a straight chain or branched alkyl group having 4 to 12 carbon atoms

Examples of the straight chain alkyl group having 4 to 12 carbon atoms include butyl group, pentyl group, hexyl group, heptyl group, octyl group, nonyl group, decyl group, undecyl group, and dodecyl group.

Examples of branched alkyl groups having 4 to 12 carbon atoms include 1-methylpropyl group (sec-butyl group), 2-methylpropyl group, 1,1-dimethylethyl group (tert-butyl group), 1-methylbutyl group, 1,1-dimethylpropyl group, 1,2-dimethylpropyl group, 2,2-dimethylpropyl group (neopentyl group), 1-methylpentyl group, 2-methylpentyl group, 3-methylpentyl group, 4-methylpentyl group, 1,1-dimethylbutyl group, 1,2-dimethylbutyl group, 1,3-dimethylbutyl group, 2,2-dimethylbutyl group, 2,3-dimethylbutyl group, 1-ethylbutyl group, 2-ethylbutyl group, 1-methylhexyl group, 2-methylhexyl group, 3-methylhexyl group, 4-methylhexyl group, 5-methylhexyl group, 1-ethylpentyl group, 2-ethylpentyl group, 3-ethylpentyl group, 1,1-dimethylpentyl group, 1,2-dimethylbutyl group, ethylpentyl group, 1,3-dimethylpentyl group, 2,2-dimethylpentyl group, 2,3-dimethylpentyl group, 1-methylheptyl group, 2-methylheptyl group, 3-methylheptyl group, 4-methylheptyl group, 5-methylheptyl group, 6-methylheptyl group, 1,1-dimethylhexyl group, 1,2-dimethylhexyl group, 1,3-dimethylhexyl group, 1,4-dimethylhexyl group, 1,5-dimethylhexyl group, Methylhexyl group, 1-ethylhexyl group, 2-ethylhexyl group, 1-methyloctyl group, 2-methyloctyl group, 3-methyloctyl group, 4-methyloctyl group, 5-methyloctyl group, 6-methyloctyl group, 7-methyloctyl group, 1,1-dimethylheptyl group, 1,2-dimethylheptyl group, 1,3-dimethylheptyl group, 1,4-dimethylheptyl group, 1,5-dimethylheptyl group, 1,6-dimethylheptyl group, 1-ethylheptyl group, 2-ethylheptyl group, 1-methylnonyl group, 2-methylnonyl group, 3-methylnonyl group, 4-methylnonyl group, 5-methylnonyl group, 6-methylnonyl group, 7-methylnonyl group, 8-methylnonyl group, 1,1-dimethyloctyl group, 1,2-dimethyloctyl group, 1,3-dimethyloctyl group, 1,4-dimethyloctyl group, 1,5-Dimethyloctyl group, 1,6-dimethyloctyl group, 1,7-dimethyloctyl group, 1-ethyloctyl group, 2-ethyloctyl group, 1-methyldecyl group, 2-methyldecyl group, 3-methyldecyl group, 4-methyldecyl group, 5-methyldecyl group, 6-methyldecyl group, 7-methyldecyl group, 8-methyldecyl group, 9-methyldecyl group, 1,1-dimethylnonyl group, 1,2-dimethylnonyl group, 1,3-dimethylnonyl group, 1,4-dimethylnonyl group, 1,5-dimethylnonyl group, 1,6-dimethylnonyl group, 1,7-dimethylnonyl group, 1,8-dimethylnonyl group, 1-ethylnonyl group, 2-ethylnonyl group, 1-methylundecyl group, 2-methylundecyl group, 3-methylundecyl group, 4-methylundecyl group, 5-methylundecyl group, 6-methylundecyl group, 7-methylundecyl group, 8-methylundecyl group, 9-methylundecyl group, 10-methylundecyl group, 1,1-dimethyldecyl group, 1,2-dimethyldecyl group, 1,3-dimethyldecyl group, 1,4-dimethyldecyl group, 1,5-dimethyldecyl group, 1,6-dimethyldecyl group, 1,7-dimethyldecyl group, 1,8-dimethyldecyl group, 1,9-dimethyldecyl group, 1-ethyldecyl group, 2-ethyldecyl group. Among these, 2-ethylhexyl group is particularly preferred.
(a22) Ester compound in which R² is a branched alkyl group having 13 to 36 carbon atoms

Examples of branched alkyl groups having 13 to 36 carbon atoms include 1-alkylalkyl groups [1-methyldodecyl group, 1-butyleicosyl group, 1-hexyloctadecyl group, 1-octylhexadecyl group, 1-decyltetradecyl group; 1-undecyltridecyl group, etc.], 2-alkylalkyl group [2-methyldodecyl group, 2-hexyloctadecyl group, 2-octylhexadecyl group, 2-decyltetradecyl group, 2-undecyltridecyl group, 2-dodecylhexadecyl group, 2-tridecylpentadecyl group, 2-decyl octadecyl group, 2-tetradecyl octadecyl group, 2-hexadecyl octadecyl group, 2-tetradecyl eicosyl group, 2-hexadecyl eicosyl group groups], 3-34-alkylalkyl groups (3-alkylalkyl group, 4-alkylalkyl group, 5-alkylalkyl group, 32-alkylalkyl group, 33-alkylalkyl group, 34-alkylalkyl group, etc.), or mixed alkyl groups containing one or more branched alkyl groups, such as the residue of an oxo alcohol with the hydroxyl group removed, wherein the oxo alcohol is obtained from Propylene oligomer (7-11 mer), ethylene/propylene (molar ratio 16/1-1/11) oligomer, isobutylene oligomer (7-8 mer), and α-olefin (5-20 carbon atoms) oligomer (4-octamer) and the like.

The polymer compound constituting the coating layer may contain, as the acrylic monomer (a), an ester compound (a3) consisting of a monovalent aliphatic alcohol with 1 to 3 carbon atoms and (meth)acrylic acid.

Examples of the monovalent aliphatic alcohol with 1 to 3 carbon atoms constituting the ester compound (a3) include methanol, ethanol, 1-propanol, and 2-propanol. It is noted that (meth)acrylic acid means acrylic acid or methacrylic acid.

The polymer compound constituting the coating layer is preferably a polymer of a monomer composition containing acrylic acid (a0) and at least one of monomer (a1), monomer (a2), and ester compound (a3). More preferably, the coating resin is a polymer of a monomer composition containing acrylic acid (a0) and at least one of a monomer (a1), an ester compound (a21), and an ester compound (a3). Further preferably, the coating resin is a polymer of a monomer composition containing acrylic acid (a0) and any one of monomer (a1), monomer (a2), and ester compound (a3). Most preferably, the coating resin is a polymer of a monomer composition comprising acrylic acid (a0) and any one of a monomer (a1), an ester compound (a21), and an ester compound (a3). As the polymer compound constituting the coating layer, examples include a copolymer of acrylic acid and maleic acid using maleic acid as the monomer (a1), a copolymer of acrylic acid and 2-ethylhexyl methacrylate using 2-ethylhexyl methacrylate as the monomer (a2), a copolymer of acrylic acid and methyl methacrylate using methyl methacrylate as the ester compound (a3).

From the point of suppressing volume change of cathode active material particles, the total content of monomer (a1), monomer (a2) and ester compound (a3) is preferably 2.0 to 9.9% by weight, more preferably 2.5 to 7.0% by weight based on the weight of the entire monomer.

Preferably, the polymer compound constituting the coating layer does not contain, as the acrylic monomer (a), a salt (a4) of an anionic monomer having a polymerizable unsaturated double bond and an anionic group.

The structure having the polymerizable unsaturated double bond include a vinyl group, an allyl group, a styrenyl group, and a (meth)acryloyl group. Examples of the anionic group include a sulfonic acid group and a carboxyl group. An anionic monomer having a polymerizable unsaturated double bond and an anionic group is a compound obtained by a combination of these. Examples include vinylsulfonic acid, allylsulfonic acid, styrenesulfonic acid and (meth)acrylic acid. Herein, a (meth)acryloyl group means an acryloyl group or a methacryloyl group. Examples of the cations constituting the anionic monomer salt (a4) include lithium ions, sodium ions, potassium ions, and ammonium ions.

In addition, within the range of its physical properties, the polymer compound constituting the coating layer may contain, as the acrylic monomer (a), a radically polymerizable monomer (a5) that is copolymerizable with acrylic acid (a0), monomer (a1), monomer (a2), and ester compound (a3). The radically polymerizable monomer (a5) is preferably a monomer that does not contain active hydrogen, and the following monomers (a51) to (a58) can be used.
(a51) Hydrocarbyl (meth)acrylate constituting (meth)acrylic acid and one of straight chain aliphatic monool having 13 to 20 carbon atoms, at least one of monools among an alicyclic monool having 5 to 20 carbon atoms and an aromatic aliphatic monool having 7 to 20 carbon atoms

The monools include (i) straight chain aliphatic monools (tridecyl alcohol, myristyl alcohol, pentadecyl alcohol, cetyl alcohol, heptadecyl alcohol, stearyl alcohol, nonadecyl alcohol, arachidyl alcohol, etc.), (ii) alicyclic monools (cyclopentyl alcohol, cyclohexyl alcohol, cycloheptyl alcohol, cyclooctyl alcohol, etc.), (iii) aromatic aliphatic monools (benzyl alcohol, etc.), and mixtures of two or more thereof.
(a52) Poly (n=2-30) oxyalkylene (2-4 carbon atoms) alkyl (1-18 carbon atoms) ether (meth)acrylate [10 mole adduct (meth)acrylate of ethylene oxide (hereinafter abbreviated as EO) to methanol, 10 mole adduct (meth)acrylate of propylene oxide (hereinafter abbreviated as PO) to methanol, etc.]
(a53) Nitrogen-containing vinyl compound
(a53-1) Vinyl compound containing amide group
(i) (meth)acrylamide compounds having 3 to 30 carbon atoms, such as N, N-dialkyl (1 to 6 carbon atoms) or diallkyl (7 to 15 carbon atoms) (meth)acrylamide (N, N-dimethylacrylamide, N/N-dibenzylacrylamide, etc.), diacetone acrylamide
(ii) Vinyl compounds containing an amide group having 4 to 20 carbon atoms, excluding the above (meth)acrylamide compounds, such as N-methyl-N-vinylacetamide, cyclic amide [pyrrolidone compounds (having 6 to 13 carbon atoms, such as N-vinylpyrrolidone, etc.)]
(a53-2) (meth)acrylate compound
(i) Dialkyl (1 to 4 carbon atoms) aminoalkyl (1 to 4 carbon atoms) (meth)acrylate [N, N-dimethylaminoethyl (meth)acrylate, N, N-diethylaminoethyl (meth)acrylate, t-Butylaminoethyl (meth)acrylate, morpholinoethyl (meth)acrylate, etc.]
(ii) (meth)acrylate containing quaternary ammonium group {(meth)acrylate containing tertiary amino group [N, N-dimethylaminoethyl (meth)acrylate, N, N-diethylaminoethyl (meth)acrylate, etc.] quaternized compounds (quaternized using a quaternizing agent such as methyl chloride, dimethyl sulfate, benzyl chloride, dimethyl carbonate, etc.), etc.}
(a53-3) Vinyl compound containing heterocycle

Pyridine compounds (7 to 14 carbon atoms, e.g. 2- or 4-vinylpyridine), imidazole compounds (5 to 12 carbon atoms, e.g. N-vinylimidazole), pyrrole compounds (6 to 13 carbon atoms, e.g. N-vinylpyrrole), pyrrolidone compound (6 to 13 carbon atoms, e.g. N-vinyl-2-pyrrolidone)
(a53-4) Vinyl compound containing nitrile groups

Vinyl compound containing nitrile groups having 3 to 15 carbon atoms, such as (meth)acrylonitrile, cyanostyrene, cyanoalkyl (1 to 4 carbon atoms) acrylates
(a53-5) Vinyl compound containing other nitrogen

Vinyl compound containing nitro group (8 to 16 carbon atoms, such as nitrostyrene), etc.
(a54) Vinyl hydrocarbon
(a54-1) Aliphatic vinyl hydrocarbon

Olefins having 2 to 18 carbon atoms or more (ethylene, propylene, butene, isobutylene, pentene, heptene, diisobutylene, octene, dodecene, octadecene, etc.), dienes having 4 to 10 carbon atoms or more (butadiene, isoprene, 1,4-pentadiene, 1,5-hexadiene, 1,7-octadiene, etc.) etc.
(a54-2) Alicyclic vinyl hydrocarbon

Cyclic unsaturated compounds having from 4 to 18 carbon atoms or more, such as cycloalkenes (e.g. cyclohexene), (di)cycloalkadienes [e.g. (di)cyclopentadiene], terpenes (e.g. pinene and limonene), indenes
(a54-3) Aromatic vinyl hydrocarbon

Aromatic unsaturated compounds having 8 to 20 carbon atoms or more, such as styrene, α-methylstyrene, vinyltoluene, 2,4-dimethylstyrene, ethylstyrene, isopropylstyrene, butylstyrene, phenylstyrene, cyclohexylstyrene, benzylstyrene
(a55) Vinyl ester

Aliphatic vinyl esters [4 to 15 carbon atoms, such as alkenyl esters of aliphatic carboxylic acids (mono- or dicarboxylic acids) (such as vinyl acetate, vinyl propionate, vinyl butyrate, diallyl adipate, isopropenyl acetate, vinyl methoxy acetate)]

Aromatic vinyl esters [9 to 20 carbon atoms, such as alkenyl esters of aromatic carboxylic acids (mono- or dicarboxylic acids) (such as vinyl benzoate, diallyl phthalate, methyl-4-vinyl benzoate), aromatic ring-containing aliphatic carboxylic acids ester (e.g. acetoxystyrene)]
(a56) Vinyl ether

Aliphatic vinyl ethers [3 to 15 carbon atoms, such as vinyl alkyl (1 to 10 carbon atoms) ethers (vinyl methyl ether, vinyl butyl ether, vinyl 2-ethylhexyl ether, etc.), vinyl alkoxy (1 to 6 carbon atoms) alkyl (carbon atoms 1-4) Ethers (vinyl-2-methoxyethyl ether, methoxybutadiene, 3,4-dihydro-1,2-pyran, 2-butoxy-2′-vinyloxydiethyl ether, vinyl-2-ethylmercaptoethyl ether, etc.)), poly(2-4) (meth)allyloxyalkane (carbon number 2-6) (diallyloxyethane, triallyloxyethane, tetraallyloxybutane, tetramethallyloxyethane, etc.)], aromatic vinyl ether (8 to 20 carbon atoms, e.g. vinyl phenyl ether, phenoxystyrene)
(a57) Vinyl ketone

Aliphatic vinyl ketones (4 to 25 carbon atoms, e.g. vinyl methyl ketone, vinyl ethyl ketone), aromatic vinyl ketones (9 to 21 carbon atoms, e.g. vinyl phenyl ketone)
(a58) unsaturated dicarboxylic acid diester unsaturated

Dicarboxylic acid diester having 4 to 34 carbon atoms, for example, dialkyl fumarate (two alkyl groups are linear, branched or alicyclic groups having 1 to 22 carbon atoms), dialkyl maleate (two alkyl groups are linear, branched or alicyclic groups having 1 to 22 carbon atoms)

When the radically polymerizable monomer (a5) is contained, the content thereof based on the weight of all monomers is preferably 0.1 to 3.0 wt %.

A preferable lower limit of the weight average molecular weight of polymer compound constituting the coating layer is 3,000, a more preferable lower limit is 5,000, and a still more preferable lower limit is 7,000. On the other hand, a preferable upper limit of the weight average molecular weight of coating resin is 100,000, and a more preferable upper limit is 70,000.

The weight average molecular weight of the polymer compound constituting the coating layer can be obtained by gel permeation chromatography (hereinafter abbreviated as GPC) measurement under the following conditions.
Device: Alliance GPC V2000 (commercially available from Waters)
Solvent: ortho-dichlorobenzene, DMF, THF
Standard substance: polystyrene
Sample concentration: 3 mg/ml
Column stationary phase: PLgel 10 μm, MIXED-B 2 columns in series (commercially available from Polymer Laboratories Ltd.)
Column temperature: 135° C.

The polymer compound constituting the coating layer can be produced using a known polymerization initiator {azo initiator [2,2′-azobis(2-methylpropionitrile), 2,2′-azobis(2,4-dimethylvaleronitrile), 2,2′-azobis(2-methylbutyronitrile), etc.], peroxide initiator (benzoyl peroxide, di-t-butyl peroxide, lauryl peroxide, etc.) or the like} by a known polymerization method (bulk polymerization, solution polymerization, emulsion polymerization, suspension polymerization, etc.). In order to adjust the weight-average molecular weight to be within a preferable range, the amount of the polymerization initiator used based on the total weight of the monomers is preferably 0.01 to 5 wt %, more preferably 0.05 to 2 wt %, and still more preferably 0.1 to 1.5 wt %, and the polymerization temperature and the polymerization time are adjusted depending on the type of the polymerization initiator and the like, and polymerization is performed at a polymerization temperature of preferably-5 to 150° C., (more preferably 30 to 120° C.) for a reaction time of preferably 0.1 to 50 hours (more preferably 2 to 24 hours).

Examples of solvents used in the solution polymerization include esters (with 2 to 8 carbon atoms, for example, ethyl acetate and butyl acetate), alcohols (with 1 to 8 carbon atoms, for example, methanol, ethanol and octanol), hydrocarbons (with 4 to 8 carbon atoms, for example, n-butane, cyclohexane and toluene), amides (for example, DMF)) and ketones (with 3 to 9 carbon atoms, for example, methyl ethyl ketone). In order to adjust the weight-average molecular weight to be within a preferable range, the amount thereof used based on the total weight of the monomers is preferably 5 to 900 wt %, more preferably 10 to 400 wt %, and still more preferably 30 to 300 wt %, and the monomer concentration is preferably 10 to 95 wt %, more preferably 20 to 90 wt %, and still more preferably 30 to 80 wt %.

Examples of dispersion media for emulsion polymerization and suspension polymerization include water, alcohols (for example, ethanol), esters (for example, ethyl propionate), and light naphtha, and examples of emulsifiers include (C10-C24) higher fatty acid metal salts (for example, sodium oleate and sodium stearate), (C10-C24) higher alcohol sulfate metal salts (for example, sodium lauryl sulfate), ethoxylated tetramethyldecynediol, sodium sulfoethyl methacrylate, and dimethylaminomethyl methacrylate. In addition, polyvinyl alcohol, polyvinylpyrrolidone or the like may be added as the stabilizer. The monomer concentration of the solution or dispersion liquid is preferably 5 to 95 wt %, more preferably 10 to 90 wt %, and still more preferably 15 to 85 wt %, and the amount of the polymerization initiator used based on the total weight of the monomers is preferably 0.01 to 5 wt %, and more preferably 0.05 to 2 wt %. During polymerization, a known chain transfer agent, for example, a mercapto compound (dodecyl mercaptan, n-butyl mercaptan, etc.) and/or a halogenated hydrocarbon (carbon tetrachloride, carbon tetrabromide, benzyl chloride, etc.), can be used.

The polymer compound constituting the coating layer may be a crosslinked polymer obtained by cross-linking said polymer with a cross-linking agent (A′) having a reactive functional group that reacts with a carboxyl group {preferably a polyepoxy compound (a′1) [polyglycidyl ether (bisphenol A diglycidyl ether, propylene glycol diglycidyl ether, glycerin triglycidyl ether, etc.), polyglycidylamine (N, N-diglycidylaniline and 1,3-bis(N, N-diglycidylaminomethyl)) and the like] and/or a polyol compound (a′2) (ethylene glycol, etc.)}.

Examples of methods of cross-linking a polymer compound constituting the coating layer using a cross-linking agent (A′) include a method of coating anode active material particles with a polymer compound constituting the coating layer and then performing cross-linking. Specifically, a method in which anode active material particles and a resin solution containing a polymer compound constituting a coating layer are mixed, the solvent is removed to produce coated anode active material particles, and a solution containing the cross-linking agent (A′) is then mixed with the coated anode active material particles and heated, and thus the solvent is removed, a cross-linking reaction is caused, and a reaction in which the polymer compound constituting the coating layer is cross-linked with the cross-linking agent (A′) is caused on the surface of anode active material particles may be exemplified. The heating temperature is adjusted depending on the type of the cross-linking agent, and when the polyepoxy compound (a′1) is used as the cross-linking agent, the heating temperature is preferably 70° C. or higher, and when the polyol compound (a′2) is used, the heating temperature is preferably 120° C. or higher.

The coating layer may further contain a conductive assistant and ceramic particles in addition to the polymer compound. Examples of conductive assistants include metals [aluminum, stainless steel (SUS), silver, gold, copper, titanium, etc.], carbon [graphite (Flake graphite (UP)), carbon black (acetylene black, ketjen black, furnace black, channel black, thermal lamp black, etc.) and carbon nanofiber (CNF) and the like], and mixtures thereof. However, the conductive assistant is preferably the first conductive filler described below, that is, a conductive filler having an aspect ratio of 10 or less. On the other hand, it is preferable that the coating layer does not contain a second conductive filler (conductive filler having an aspect ratio of 15 or more), which will be described later. When the coating layer contains the conductive filler with an aspect ratio of 15 or more, the aggregates of the first conductive filler and the second conductive filler may be formed in the coating layer.

The ratio of the polymer compound and the conductive assistant constituting the coating layer is not particularly limited. However, from the viewpoint of internal resistance of the battery, etc., the weight ratio of the polymer compound (resin solid content weight) constituting the coating layer to the conductive assistant is preferably 1:0.01 to 1:50, and more preferably 1:0.2 to 1:3.0.

Examples of ceramic particles include metal carbide particles, metal oxide particles, and glass ceramic particles.

Examples of metal carbide particles include silicon carbide (Sic), tungsten carbide (WC), molybdenum carbide (MO₂C), titanium carbide (TiC), tantalum carbide (TaC), niobium carbide (NbC), vanadium carbide (VC), and zirconium carbide (ZrC).

Examples of metal oxide particles include particles of zinc oxide (ZnO), aluminum oxide (Al₂O₃), silicon dioxide (SiO₂), tin oxide (SnO₂), titania (TiO₂), zirconia (ZrO₂), indium oxide (In₂O₃), Li₂B₄O₇, Li₄Ti₅O₁₂, Li₂Ti₂O₅, LiTaO₃, LiNbO₃, LiAlO₂, Li₂ZrO₃, Li₂WO₄, Li₂TiO₃, Li₃PO₄, Li₂MoO₄, Li₃BO₃, LiBO₂, Li₂CO₃, Li₂SiO₃ and a perovskite oxide represented by ABO₃ (where, A is at least one selected from the group consisting of Ca, Sr, Ba, La, Pr and Y, and B is at least one selected from the group consisting of Ni, Ti, V, Cr, Mn, Fe, Co, Mo, Ru, Rh, Pd and Re). As the metal oxide particles, in order to suitably inhibit a side reaction between the electrolytic solution and the coated anode active material particles, Zinc oxide (ZnO), aluminum oxide (Al₂O₃), silicon dioxide (SiO₂), and lithium tetraborate (Li₂B₄O₇) are preferable,

The glass ceramic particles are preferably a lithium-containing phosphate compound having a rhombohedral crystal system and a chemical formula thereof is represented by LiₓM″₂P₃O₁₂ (X=1 to 1.7). Here, M″ is one or more elements selected from the group consisting of Zr, Ti, Fe, Mn, Co, Cr, Ca, Mg, Sr, Y, Sc, Sn, La, Ge, Nb, and Al. In addition, some P may be replaced with Si or B, and some 0 may be replaced with or Cl the like. For example, Li_{1.15}Ti_{1.85}Al_{2.15}Si_{0.05}P_{2.95}O₁₂, Li_{1.2}Ti_{1.8}Al_{2.1}Ge_{0.1}Si_{0.05}P_{2.95}O₁₂ or the like can be used. In addition, materials with different compositions may be mixed or combined, and the surface may be coated with a glass electrolyte or the like. Alternatively, it is preferable to use glass ceramic particles that precipitate a crystal phase of a lithium-containing phosphate compound having a NASICON type structure according to a heat treatment. Examples of glass electrolytes include the glass electrolyte described in Japanese Patent Application Publication No. 2019-96478.

Here, the mixing proportion of Li₂O in the glass ceramic particles is preferably 8 mass % or less in terms of oxide. In addition to a NASICON type structure, a solid electrolyte which is composed of Li, La, Mg, Ca, Fe, Co, Cr, Mn, Ti, Zr, Sn, Y, Sc, P, Si, O, In, Nb, or F, has a LISICON type, perovskite type, β-Fe₂(SO₄)₃ type, or Li₃In₂(PO₄)₃ type crystal structure, and transmits 1×10⁻⁵ S/cm or more of Li ions at room temperature may be used.

The above ceramic particles may be used alone or two or more thereof may be used in combination.

In consideration of the energy density and electrical resistance value, the volume average particle size of the ceramic particles is preferably 1 to 1,200 nm, more preferably 1 to 500 nm, and still more preferably 1 to 150 nm.

The weight proportion of the ceramic particles is preferably 1.0 to 5.0 wt % based on the weight of the coated cathode active material particles. With the ceramic particles contained in the above range, side reactions between the electrolytic solution and the coated cathode active material particles can be suitably suppressed. The weight proportion of the ceramic particles is preferably 2.0 to 4.0 wt % based on the weight of the coated cathode active material particles.

The coated cathode active material particles may have two or more coating layers. When the coating layer has two or more layers, the composition of the polymer compound contained in each coating layer may be the same or different. Furthermore, when the coating layer contains a conductive assistant and ceramic particles, the types of the conductive assistant and the ceramic particles contained in each coating layer may be the same or different.

The coated cathode active material particles preferably have a true density of 3.2 to 4.7 g/ml. The true density affects the flowability of the composition. Therefore, in a case when the true density of the coated cathode active material particles is within the above range, the ratio of the aerated bulk density to the packed bulk density of the cathode composition for lithium-ion batteries of the present invention can be easily adjusted to be within the above range. The coated cathode active material particles may have a true density of 3.3 to 4.6 g/ml. In this specification, the true density of the coated cathode active material particles is a value measured by a liquid phase displacement method.

The method of producing coated cathode active material particles includes a step of removing a solvent after mixing cathode active material particles, a polymer compound, an optionally used conductive assistant, an optionally used ceramic particles, and an organic solvent.

The organic solvent is not particularly limited as long as it can dissolve the polymer compound, and any known organic solvent can be appropriately selected and used.

In the method of producing coated cathode active material particles, first, cathode active material particles, a polymer compound constituting the coating layer, an optionally used conductive assistant, and optionally used ceramic particles are mixed in the organic solvent. In a case when the cathode active material particles, the polymer compound constituting the coating layer, the conductive assistant, and the ceramic particles are mixed, the order is not particularly limited. For example, a resin composition consisting of a polymer compound constituting the coating layer, a conductive assistant, and ceramic particles may be further mixed with the cathode active material particles, wherein the resin compound was pre-mixed. The cathode active material particles, the polymer compound constituting the coating layer, the conductive assistant, and the ceramic particles may be mixed at the same time. A polymer compound constituting the coating layer may be mixed with the cathode active material particles. Further, a conductive assistant and ceramic particles may be mixed therein.

The coated cathode active material particles can be obtained by covering cathode active material particles with a coating layer containing a polymer compound, an optionally used conductive assistant and optionally used ceramic particles, for example, while the electrode active material particles are put into a universal mixer and stirred at 30 to 500 rpm, then resin solution containing a polymer compound that forms the coating layer is added dropwise over 1 to 90 minutes and mixed, the conductive assistant and the ceramic particles are mixed, the temperature is raised to 50 to 200° C. with stirring, the pressure is reduced to 0.007 to 0.04 MPa, the sample is then left for 10 to 150 minutes, and the solvent is removed.

When the coating layer of the coated cathode active material particles has two layers, for example, after forming a first coating layer according to the above method, the coated cathode active material particles can be obtained in which a second coating layer is provided on the first coating layer by the same procedure as the above method by using a resin solution containing a polymer compound constituting the second coating layer, a conductive assistant, and ceramic particles. When the coated cathode active material particles have three or more coating layers, the coated cathode active material particles can be obtained by forming coating layers on the surfaces of the cathode active material particles in the same manner.

The mixing ratio of the cathode active material particles, and the resin composition consisting of a polymer compound constituting the coating layer, an optionally used conductive assistant, and optionally used ceramic particles is not particularly limited, and the weight ratio of the cathode active material particles:the resin composition is preferably 1:0.001 to 0.1.

At least a part of the surface of the cathode active material particles is covered with a coating layer. From the viewpoint of cycle characteristics, the coverage of the cathode active material particles is preferably 30 to 95% as obtained by the following calculation formula.

coverage (%)={1−[BET specific surface area of coated cathode active material particles/(BET specific surface area of cathode active material particles×weight proportion of cathode active material particles contained in coated cathode active material particles+BET specific surface area of conductive assistant×weight proportion of conductive assistant contained in coated cathode active material particles+BET specific surface area of ceramic particles×weight proportion of ceramic particles contained in coated cathode active material particles)]}×100

In terms of the cathode composition for lithium-ion batteries of the present invention, the weight ratio of the coated cathode active material particles is preferably 98.0 to 99.5 wt %, and more preferably 98.3 to 99.5 wt %. The weight ratio of the coated cathode active material particles may be 98.3 to 99.3 wt %.

The cathode composition for a lithium-ion batteries of the present invention contains a conductive filler. The conductive filler preferably contains a first conductive filler having an aspect ratio of 10 or less and a second conductive filler having an aspect ratio of 15 or more. By covering the coating layer surface of the coated cathode active material particles with the first conductive filler having a small aspect ratio, the tackiness of the coating layer surface can be reduced. Therefore, even if the second conductive filler having a large aspect ratio is added, the conductive filler is prevented from forming aggregates on the surface of the coating layer and good fluidity can be added to the cathode composition for lithium-ion batteries. Therefore, since the cathode composition for lithium-ion batteries contains the first conductive filler having an aspect ratio of 10 or less and the second conductive filler having an aspect ratio of 15 or more, the ratio of the aerated bulk density to the packed bulk density of the cathode composition for lithium-ion batteries can be easily adjusted within the above range.

### (First Conductive Filler)

The first conductive filler has an aspect ratio of 10 or less. The first conductive filler is not particularly limited as long as it satisfies the above aspect ratio. Examples of the first conductive filler include metals [aluminum, stainless steel (SUS), silver, gold, copper, titanium, etc.], carbon [graphite (flake graphite (UP)), and carbon black (acetylene black (AB), chain black (KB), furnace black, channel black, thermal lamp black, etc.), and mixtures thereof. Among them, from the viewpoint of suitably satisfying the ratio of the aerated bulk density to the packed bulk density of the cathode composition for lithium-ion batteries within the above range, acetylene black (AB), Ketjen black (KB), or flaky graphite (UP) is preferred.

The first conductive filler preferably has an aspect ratio of 5 or less, more preferably 3 or less from the viewpoint of suitably satisfying the ratio of the aerated bulk density to the packed bulk density of the cathode composition for lithium-ion batteries within the above range.

In this specification, the term “aspect ratio” refers to the average value of the ratio of the long axis (y) to the short axis (x) [long axis (y)/short axis (x)], when measuring the short axis (x) and long axis (y) of 30 particles by using observation means such as a scanning electron microscope (SEM) or a transmission electron microscope (TEM).

The average particle diameter of the first conductive filler is not particularly limited, but from the viewpoint of the electrical characteristics of the battery, it is preferably about 0.01 to 10 μm. In this specification, the “particle size of the conductive filler” is the maximum distance L among the distances between arbitrary two points on the outline of the conductive filler. As the value of “average particle size”, the value calculated as an average value of the particle sizes of the 30 particles by using an observation device such as a scanning electron microscope (SEM) or a transmission electron microscope (TEM) is used.

### (Second Conductive Filler)

The second conductive filler has an aspect ratio of 15 or more.

The second conductive filler is not particularly limited as long as it satisfies the above aspect ratio. Examples of the second conductive filler include metals [aluminum, stainless steel (SUS), silver, gold, copper, titanium, etc.], carbon [graphite (flake graphite (UP)), and carbon black (furnace black, channel black, thermal lamp black, etc.), carbon nanofibers (CNF), etc.], and mixtures thereof. Among them, from the viewpoint of suitably satisfying the aspect ratio of the second conductive filler, carbon nanofibers (CNF) are preferred.

The second conductive filler preferably has an aspect ratio of 20 or more, more preferably 25 or more from the viewpoint of suitably forming an electron conduction path and suitably imparting electron conductivity.

Since it is easy to adjust the ratio of the aerated bulk density to the packed bulk density of the cathode composition for lithium-ion batteries within the above range, the weight ratio of the first conductive filler is preferably 0.2 to 1.0 wt %, and more preferably 0.3 to 0.8 wt %, based on the total weight of the cathode composition.

Since it is easy to adjust the ratio of the aerated bulk density to the packed bulk density of the cathode composition for lithium-ion batteries within the above range, the weight ratio of the second conductive filler is preferably 0.1 to 1.0 wt %, and more preferably 0.2 to 0.8 wt %, based on the total weight of the cathode composition for lithium-ion batteries.

In a case when the first conductive filler and the second conductive filler are used as the conductive filler, their blending ratio (weight ratio) is not particularly limited, but for example, (first conductive filler/second conductive filler) is preferably 0.5 to 5.0, and more preferably 1.0 to 2.5.

Since it is easy to adjust the ratio of the aerated bulk density to the packed bulk density of the cathode composition for lithium-ion batteries within the above range, the total weight ratio of the conductive filler is preferably 0.5 to 2.0 wt %, and more preferably 0.75 to 1.5 wt %, based on the total weight of the cathode composition for lithium-ion batteries.

Since the ratio of the aerated bulk density to the packed bulk density of the cathode composition for lithium-ion batteries of the present invention is within the above-mentioned range, cracking of the electrode obtained by compression molding using the composition can be suppressed, and an electrode with high strength can be obtained. Furthermore, by using the composition, it is possible to reduce the thickness of the electrode.

Next, a method of manufacturing the cathode composition for lithium-ion batteries according to the present invention will be explained.

In a case when the conductive filler contains a first conductive filler having an aspect ratio of 10 or less and a second conductive filler having an aspect ratio of 15 or more, for example, the cathode composition for lithium-ion batteries according to the present invention will be produced by the following manufacturing method.

The method of manufacturing the cathode composition for lithium-ion batteries includes:
a first mixing step of obtaining a powder for cathodes by mixing coated cathode active material particles, in which at least a part of the surface of the cathode active material particles is coated with a polymer compound, with a first conductive filler having an aspect ratio of 10 or less; and
a second mixing step of obtaining a cathode composition by mixing the powder for cathodes with a second conductive filler having an aspect ratio of 15 or more.

In the first mixing step, a powder for cathodes can be obtained by mixing the coated cathode active material particles, in which at least a part of the surface of the cathode active material particle is coated with a polymer compound, with a first conductive filler having an aspect ratio of 10 or less.

The mixing method in the first mixing step can be carried out using, for example, a dispersing machine or a kneading machine such as a three-roller mill, a ball mill, or a planetary ball mill. Specifically, a planetary stirring type mixing and kneading device {Awatori Rentaro [manufactured by Shinky Co., Ltd.]} can be applicable.

The rotational speed during mixing is preferably 1000 to 3000 rpm, more preferably 1500 to 2500 rpm, for example. The mixing time is preferably 1 to 30 minutes, more preferably 2 to 15 minutes.

The mixing method in the second mixing step can be carried out using, for example, a dispersing machine or a kneading machine such as a three-roller mill, a ball mill, or a planetary ball mill. Specifically, a planetary stirring type mixing and kneading device {Awatori Rentaro [manufactured by Shinky Co., Ltd.]} can be applicable.

The rotational speed during mixing is preferably 1000 to 3000 rpm, more preferably 1500 to 2500 rpm, for example. The mixing time is preferably 1 to 30 minutes, more preferably 2 to 15 minutes.

### <Cathode for Lithium-Ion Batteries>

The cathode composition for lithium-ion batteries can be used for manufacturing an cathode for lithium-ion batteries. The cathode for lithium-ion batteries includes a cathode active material layer containing a cathode composition for lithium-ion batteries and an electrolytic solution having an electrolyte and a solvent. The electrolyte and the solvent may be any known electrolyte and solvent.

The amount of the coated cathode active material particles contained in the cathode active material layer is preferably 40 to 95 wt % based on the weight of the cathode active material layer and is more preferably 60 to 90 wt % from the viewpoint of dispersibility of cathode active material particles and electrode formability.

From the viewpoint of battery performance, the thickness of the cathode active material layer is preferably 150 to 470 μm, and more preferably 200 to 460 μm.

As for the cathode for lithium-ion batteries, for example, a powder (composition for a cathode active material layer) obtained by mixing the cathode composition for lithium-ion batteries of this invention and, if necessary, a conductive assistant, etc., can also be produced by pouring the powder int an electrolytic solution after applying the powder to the current collector and pressing it with a press machine to form a cathode active material layer. In addition, it is fine that the composition for a cathode active material layer is applied onto a release film and pressed to form a cathode active material layer, and after the cathode active material layer is transferred to a current collector, the electrolytic solution may be injected. In addition, the cathodes for lithium-ion batteries may also be made when a frame member is placed on the current collector, and the composition for an cathode active material layer is filled inside the frame member to have the same thickness as the frame member.

### EXAMPLES

Next, the present invention will be described in detail with reference to examples, but the present invention is not limited to the examples as long as it does not depart from the spirit of the present invention. Here, unless otherwise specified, parts means parts by weight, and % means wt %. In the examples, the true density of the coated cathode active material particles and the like was measured by a liquid phase displacement method using an AUTO TRUE DENSER MAT-7000 (product name, manufactured by Seishin Enterprises).

[Production of Polymer Compound that Coats Cathode Active Material Particles]

150 parts of DMF was put into a 4-neck flask including a stirrer, a thermometer, a reflux cooling tube, a dropping funnel and a nitrogen gas inlet tube, and the temperature was raised to 75° C. Next, a monomer composition in which 91 parts of acrylic acid, 9 parts of methyl methacrylate and 50 parts of DMF were mixed and an initiator solution in which 0.3 parts of 2,2′-azobis(2,4-dimethylvaleronitrile) and 0.8 parts of 2,2′-azobis(2-methylbutyronitrile) were dissolved in 30 parts of DMF were continuously added dropwise over 2 hours through a dropping funnel with stirring while blowing nitrogen into the 4-neck flask to cause radical polymerization. After dropwise addition was completed, the reaction was continued at 75° C. for 3 hours.

Next, the temperature was raised to 80° C., the reaction was continued for 3 hours, and a copolymer solution having a resin concentration of 30% was obtained. The obtained copolymer solution was transferred to a Teflon (registered trademark) bat and dried under a reduced pressure at 150° C. and 0.01 MPa for 3 hours, and DMF was distilled off to obtain a copolymer. This copolymer was coarsely pulverized with a hammer and then additionally pulverized with a mortar to obtain a powdered polymer compound. The true density of the obtained polymer compound was 1.19 g/ml.

### [Production of Coated Cathode Active Material Particles 1]

1 part of the polymer compound was dissolved in 3 parts of DMF to obtain a polymer compound solution.

In a state where 89.91 parts of the cathode active material particles (LiFePO₄ powder, product name “420A”, volume average particle size 1 μm, true density 3.53 g/ml, manufactured by Sumitomo Osaka Cement Co., Ltd.) were put into a Universal Mixer High Speed Mixer FS25 [commercially available from EARTHTECHNICA Co., Ltd.] and stirred at room temperature and 720 rpm, 15.28 parts (3.82 parts in terms of solid content) of the polymer compound solution was added dropwise over 2 minutes and additionally stirred for 5 minutes.

Next, under stirring, 3.14 parts of Graphite (UP) [flaky graphite, volume average particle size 4.5 μm, true density 2.20 g/ml] as a conductive assistant, 1.05 parts of carbon nanofiber 1 (CNF1) [manufactured by Showa Denko K. K., product name “VGCF”, true density 2.10 g/ml], and 2.09 parts of SiO₂ ceramic particles (product name “AEROSIL200 PE”, manufactured by Nippon Aerosil Co., Ltd., volume average particle size 12 nm, true density 2.20 g/ml) were added over 2 minutes in a divided manner, and stirring was continued for 30 minutes.

Thereafter, the pressure was reduced to 0.01 MPa while stirring was maintained, and then the temperature was raised to 140° C. while maintaining stirring and the reduced degree of pressure. Stirring, vacuum, and temperature were maintained for 8 hours to distill off volatile components. The obtained powder was classified using a sieve with an opening of 200 μm to prepare coated cathode active material particles 1 shown in Table 1. The true density of the obtained coated cathode active material particles 1 was 3.36 g/ml.

### [Production of Coated Cathode Active Material Particles 2]

Except that the cathode active material particles were changed from LifePO₄ powder to LiNi_{0.8}Co_{0.15}Al_{0.05}O₂ powder (volume average particle size 4 μm, true density 4.80 g/ml, manufactured by BASF Toda Materials Co., Ltd.), the coated cathode active material particles 2 having the composition shown in Table 1 were obtained in the same manner as in the preparation of the coated cathode active material particles 1. The true density of the obtained coated cathode active material particles 1 was 4.50 g/ml.

### [Production of Coated Cathode Active Material Particles 3]

Except that the cathode active material particles were changed from LifePO₄ powder to LicoO₂ powder (product name “Cellseed”, volume average particle size 8 μm, true density 5.10 g/ml, manufactured by Nippon Chemical Industry Co., Ltd.), the coated cathode active material particles 3 having the composition shown in Table 1 were obtained in the same manner as in the preparation of the coated cathode active material particles 1. The true density of the obtained coated cathode active material particles 3 was 4.47 g/ml.

### [Production of Coated Cathode Active Material Particles 5]

1 part of the polymer compound was dissolved in 3 parts of DMF to obtain a polymer compound solution. In a state where 89.96 parts of LiNi_{0.8}Co0.15Al_{0.05}O₂ powder (volume average particle size 4 μm, true density 4.80 g/ml, manufactured by BASF Toda Materials Co., Ltd.) were put into a Universal Mixer High Speed Mixer FS25 [commercially available from EARTHTECHNICA Co., Ltd.] and stirred at room temperature and 720 rpm, 15.28 parts (3.90 parts in terms of solid content) of the polymer compound solution was added dropwise over 2 minutes and additionally stirred for 5 minutes. Next, under stirring, 3.12 parts of Graphite (UP) [flaky graphite, volume average particle size 4.5 μm, true density 2.20 g/ml] as a conductive assistant, 0.50 parts of Ketjenblack (KB) [manufactured by Lion Specialty Chemicals Co., Ltd., trade name “EC300J”, aspect ratio 1.5] and 2.08 parts of SiO₂ ceramic particles (product name “AEROSIL200 PE”, manufactured by Nippon Aerosil Co., Ltd., volume average particle size 12 nm, true density 2.20 g/ml) were added over 2 minutes in a divided manner, and stirring was continued for 30 minutes. Thereafter, the pressure was reduced to 0.01 MPa while stirring was maintained, and then the temperature was raised to 140° C. while maintaining stirring and the reduced degree of pressure. Stirring, vacuum, and temperature were maintained for 8 hours to distill off volatile components. The obtained powder was classified using a sieve with an opening of 200 μm to prepare coated cathode active material particles 5 shown in Table 1. The true density of the obtained coated cathode active material particles 5 was 4.50 g/ml.

TABLE 1

| | Cathode active | | Polymer | | | | | True density |
|---|---|---|---|---|---|---|---|---|
| | material particles | | Compound | UP | SiO₂ | CNF1 | KB | (g/ml) |
| Coated active material | LiFePO₄ | 89.91 | 3.82 | 3.14 | 2.09 | 1.05 | — | 3.36 |
| particles 1 | | | | | | | | |
| Coated active material | LiNi_{0.8}Co_{0.18}Al_{0.05}O₂ | 89.91 | 3.82 | 3.14 | 2.09 | 1.05 | — | 4.50 |
| particles 2 | | | | | | | | |
| Coated active material | LiCoO₂ | 89.91 | 3.82 | 3.14 | 2.09 | 1.05 | — | 4.77 |
| particles 3 | | | | | | | | |
| Coated active material | LiNi_{0.8}Co_{0.18}Al_{0.05}O₂ | 89.96 | 3.80 | 3.12 | 2.08 | — | 0.50 | 4.50 |
| particles 5 | | | | | | | | |

In Table 1, the proportion of each component constituting the coated cathode active material particles is based on wt %.

### Example 1

### [First Mixing Step]

99.25 parts of the coated cathode active material particles 1 and 0.50 parts of Ketjenblack (KB) [manufactured by Lion Specialty Chemicals Co., Ltd., trade name “EC300J”, aspect ratio 1.5] were mixed for 5 minutes at 2000 rpm using a planetary stirring type mixing and kneading device {Awatori Rentaro [manufactured by Shinky Co., Ltd.]} to produce a powder for cathodes.

### [Second Mixing Step]

99.75 parts of the powder for cathodes and 0.25 parts of carbon nanofiber (CNF2) as the second conductive filler [Dona Carbo Milled S-243 manufactured by Osaka Gas Chemical Co., Ltd.: aspect ratio 30] were mixed for 5 minutes at 2000 rpm using a planetary stirring type mixing and kneading device {Awatori Rentaro [manufactured by Shinky Co., Ltd.]} to produce a cathode composition for lithium-ion batteries.

The aerated bulk density and the packed bulk density of the obtained cathode composition for lithium-ion batteries were measured using the method described herein. The result is shown in Table 2.

### Example 2

A cathode composition for lithium-ion batteries was produced in the same manner as in Example 1, except that the coated cathode active material particles 2 were used instead of the coated cathode active material particles 1. The result is shown in Table 2.

### Example 3

A cathode composition for lithium-ion batteries was produced in the same manner as in Example 1, except that the coated cathode active material particles 3 were used instead of the coated cathode active material particles 1. The result is shown in Table 2.

### Example 4

98.50 parts of the coated cathode active material particles 3, 0.50 parts of Ketjenblack (KB) as a first conductive filler [manufactured by Lion Specialty Chemicals Co., Ltd., trade name “EC300J”, aspect ratio 1.5], and 1.00 parts of Graphite (UP) [flaky graphite, aspect rate 2.2] were mixed for 5 minutes at 2000 rpm using a planetary stirring type mixing and kneading device {Awatori Rentaro [manufactured by Shinky Co., Ltd.]} to produce a cathode composition for lithium-ion batteries. The aerated bulk density and the packed bulk density of the obtained cathode composition for lithium-ion batteries were measured using the method described herein. The result is shown in Table 2.

### Example 5

A cathode composition for lithium-ion batteries was produced in the same manner as in Example 4, except that the amount of coated cathode active material particles 3 was changed to 99.55 parts, and the amount of Graphite (UP) was changed to 0.25 parts. The result is shown in Table 2.

### Example 6

### [First Mixing Step]

99.00 parts of the coated cathode active material particles 2, 0.50 parts of Ketjenblack (KB) [manufactured by Lion Specialty Chemicals Co., Ltd., trade name “EC300J”, aspect ratio 1.5], and 0.25 parts of Graphite (UP) [flaky graphite, aspect rate 2.2] were mixed for 5 minutes at 2000 rpm using a planetary stirring type mixing and kneading device {Awatori Rentaro [manufactured by Shinky Co., Ltd.]} to produce a powder for cathodes.

### [Second Mixing Step]

99.75 parts of the powder for cathodes and 0.25 parts of carbon nanofiber (CNF2) as the second conductive filler [Dona Carbo Milled S-243 manufactured by Osaka Gas Chemical Co., Ltd.: aspect ratio 30] were mixed for 5 minutes at 2000 rpm using a planetary stirring type mixing and kneading device {Awatori Rentaro [manufactured by Shinky Co., Ltd.]} to produce a cathode composition for lithium-ion batteries.

The aerated bulk density and the packed bulk density of the obtained cathode composition for lithium-ion batteries were measured using the method described herein. The result is shown in Table 2.

### Example 7

A cathode composition for lithium-ion batteries was produced in the same manner as in Example 2, except that the amount of coated cathode active material particles 2 was changed to 98.99 parts, the amount of Ketjenblack (KB) was changed to 0.51 parts, and the amount of carbon nanofiber (CNF2) was changed to 0.50 parts. The result is shown in Table 2.

### Example 8

99.46 parts of the coated cathode active material particles 5, 0.54 parts of carbon nanofiber (CNF2) as the first conductive filler [Dona Carbo Milled S-243 manufactured by Osaka Gas Chemical Co., Ltd.: aspect ratio 30] were mixed for 5 minutes at 2000 rpm using a planetary stirring type mixing and kneading device {Awatori Rentaro [manufactured by Shinky Co., Ltd.]} to produce a cathode composition for lithium-ion batteries. The aerated bulk density and the packed bulk density of the obtained cathode composition for lithium-ion batteries were measured using the method described herein. The result is shown in Table 2.

### Comparison 1

99.50 parts of the coated cathode active material particles 2 and 0.50 parts of Ketjenblack (KB) as a first conductive filler [manufactured by Lion Specialty Chemicals Co., Ltd., trade name “EC300J”, aspect ratio 1.5] were mixed for 5 minutes at 2000 rpm using a planetary stirring type mixing and kneading device {Awatori Rentaro [manufactured by Shinky Co., Ltd.]} to produce a cathode composition for lithium-ion batteries. The aerated bulk density and the packed bulk density of the obtained cathode composition for lithium-ion batteries were measured using the method described herein. The result is shown in Table 2.

TABLE 2

| | Coated cathode active | | | | | Second | | First conductive | | | |
|---|---|---|---|---|---|---|---|---|---|---|---|
| | material particles | | First conductive | | | conductive | Total of | filler/Second | Bulk density | | |
| | | Mixing | filler | | | filler | conductive | conductive | Aerated/ | Aerated | Packed |
| | Type | proportion | KB | UP | CNF2 | CNF2 | fillers | filler | Packed | (g/ml) | (g/ml ) |
| Example 1 | 1 | 99.25 | 0.50 | 0.00 | 0.00 | 0.25 | 0.75 | 2.0 | 0.58 | 1.30 | 2.26 |
| Example 2 | 2 | 99.25 | 0.50 | 0.00 | 0.00 | 0.25 | 0.75 | 2.0 | 0.57 | 1.25 | 2.21 |
| Example 3 | 3 | 99.25 | 0.50 | 0.00 | 0.00 | 0.25 | 0.75 | 2.0 | 0.64 | 1.32 | 2.07 |
| Example 4 | 3 | 98.50 | 0.50 | 1.00 | 0.00 | 0.00 | 1.50 | — | 0.65 | 1.29 | 1.98 |
| Example 5 | 3 | 99.25 | 0.50 | 0.25 | 0.00 | 0.00 | 0.75 | — | 0.63 | 1.35 | 2.14 |
| Example 6 | 2 | 99.00 | 0.50 | 0.25 | 0.00 | 0.25 | 1.00 | 3.0 | 0.60 | 1.24 | 2.08 |
| Example 7 | 2 | 98.99 | 0.51 | 0.00 | 0.00 | 0.50 | 1.01 | 1.0 | 0.55 | 1.30 | 2.36 |
| Example 8 | 5 | 99.46 | 0.00 | 0.00 | 0.54 | 0.00 | 0.54 | — | 0.47 | 0.90 | 1.90 |
| Comparison 1 | 2 | 99.50 | 0.50 | 0.00 | 0.00 | 0.00 | 0.50 | — | 0.70 | 1.56 | 2.23 |

### <Evaluation of Electrode Properties>

100 parts of the cathode composition for lithium-ion batteries, which were obtained in Example 1, were placed in a powder inlet set in a roll press machine, and a composition for a cathode active material layer was molded under the following conditions. The cathode active material layer discharged from the roll press machine had a uniform thickness of 426 μm, and no cracks were visually observed on the surface. Herein, the thickness of the cathode active material layer was measured with a micrometer.

The conditions of the roll press machine are as follows:
Roll size: 250 mmφ×400 mm
Roll rotation speed: 1 m/min
Roll gap: 350 μm
Pressure: 10 kN (linear pressure: 25 kN/m)

Next, the strength of the cathode active material layer obtained above was measured as follows. The yield stress of the obtained cathode active material layer (sample size: 15×0.42 mm) was measured using an autograph (manufactured by Shimadzu Corporation) in accordance with ISO 178 (Plastics—Determination of bending properties), and the electrode strength was evaluated according to the following criteria. The results are shown in Table 3. First, a sample of the cathode active material layer was set on a jig with a support distance of 5 mm, and a load cell (rated load: 20 N) set on an autograph was lowered toward the electrode at a rate of 1 mm/min to calculate the yield stress at the yield point. The results are shown in Table 3.

As for the cathode composition for lithium-ion batteries of Examples 2 to 7 and Comparison 1, cathode active material layers were prepared in the same manner as in Example 1, and the presence or absence of cracks on the surface was visually confirmed, and the thickness and strength were measured. The results are shown in Table 3. As for the cathode composition for lithium-ion batteries of Example 8, the cathode active material layer was prepared in the same manner as in Example 1 and the surface was visually inspected, and no cracks were found.

Regarding surface cracks on the cathode active material layer, those in which no cracks were visually observed on the surface were marked with a ∘, and those in which cracks were observed were marked with an ×. Regarding the strength of the cathode active material layer, those having a strength of 120 kPa or more were marked with a ∘, those having a strength between 95 kPa and 120 kPa were marked with a Δ, and those having a strength of less than 95 kPa were marked with an ×. Regarding the thickness of the cathode active material layer, those having a thickness of 470 μm or less were marked with a ∘, and those having a thickness of more than 470 μm were marked with an ×.

TABLE 3

| | Electrode particles | | | | |
|---|---|---|---|---|---|
| | | Strength | | | |
| | | Yield | | | |
| | | Point | | Thickness | |
| | Crack | (kPa) | Judgement | (μm) | Judgement |
| Example 1 | ∘ | 122 | ∘ | 426 | ∘ |
| Example 2 | ∘ | 125 | ∘ | 451 | ∘ |
| Example 3 | ∘ | 126 | ∘ | 425 | ∘ |
| Example 4 | ∘ | 99 | Δ | 422 | ∘ |
| Example 5 | ∘ | 99 | Δ | 413 | ∘ |
| Example 6 | ∘ | 107 | Δ | 430 | ∘ |
| Example 7 | ∘ | 125 | ∘ | 430 | ∘ |
| Comparison 1 | x | 121 | ∘ | 485 | x |

The cathode active material layers obtained using the cathode compositions for lithium-ion batteries of Examples 1 to 7 had no cracks on the surface, the strength having 95 kPa or more to less than 120 kPa or 120 kPa or more, and the thickness having 470 μm or less. The cathode active material layers of Examples 1-3 and 6-7 containing the first conductive filler and the second conductive filler had high strength. The cathode active material layers of Examples 1-3 and 1-7, in which the ratio of the first conductive filler to the second conductive filler was 1.0 to 2.5, had particularly high strength. In terms of the cathode compositions for lithium-ion batteries of Comparison 1, the ratio of the aerated bulk density to the packed bulk density was not within the range of the present invention, cracks were confirmed on the surface of the cathode active material layer, and the strength of the cathode active material layer was also insufficient. Therefore, these were not suitable as a cathode composition for lithium-ion batteries.

### INDUSTRIAL APPLICABILITY

The cathode composition for lithium-ion batteries is available, especially as a cathode composition for producing lithium-ion batteries used for mobile phones, personal computers, hybrid vehicles, electric vehicles, and so on.

1. A cathode composition for lithium-ion batteries comprising:
a coated cathode active material particle, wherein at least a part of a cathode active material particle surface is coated by a coating layer that contains a polymer compound; and
a conductive filler,
wherein the ratio of an aerated bulk density to a packed bulk density (aerated bulk density/packed bulk density) is 0.47 to 0.65.

2. The cathode composition for lithium-ion batteries according to claim 1,
wherein the true density of the coated cathode active material particle is 3.2 to 4.7 g/ml.

3. The cathode composition for lithium-ion batteries according to claim 1,
wherein the weight ratio of the conductive filler is 0.5 to 2.0 wt % based on the total weight of the cathode composition for lithium-ion batteries.

4. The cathode composition for lithium-ion batteries according to claim 1,
wherein the conductive filler contains a first conductive filler having an aspect ratio of 10 or less and a second conductive filler having an aspect ratio of 15 or more.

5. The cathode composition for lithium-ion batteries according to claim 4,
wherein the weight ratio of the first conductive filler is 0.2 to 1.0 wt % based on the total weight of the cathode composition for lithium-ion batteries.

6. The cathode composition for lithium-ion batteries according to claim 4,
wherein the weight ratio of the second conductive filler is 0.1 to 1.0 wt % based on the total weight of the cathode composition for lithium-ion batteries.
